(19) United States
(12) Patent Application Publication
(10) Pub. No.: US 2022/0376229 A1
(43) Pub. Date: Nov. 24, 2022

(54) Lithium-Ion Battery Cathode Materials with Selenium Additives for Stable Cycling at High Voltage

(71) Applicant: Massachusetts Institute of Technology, Cambridge, MA (US)

(72) Inventors: Ju LI, Weston, MA (US); Zhi Zhu, Malden, MA (US)

(73) Assignee: Massachusetts Institute of Technology, Cambridge, MA (US)

(21) Appl. No.: 17/314,729

(22) Filed: May 7, 2021

(51) Int. Cl. H01M 4/36; H01M 4/505; H01M 4/525; H01M 4/04

(52) U.S. Cl. CPC H01M 4/366; H01M 4/505; H01M 4/525; H01M 4/043; H01M 2004/028

(57) ABSTRACT

A cathode particle includes a core and an additive. The core includes a lithium (Li) transition metal (M) oxide. The additive, which may be a coating, is disposed at least on an outer surface of the core. The additive includes at least one of selenium (Se), phosphorus (P), boron (B), or tellurium (Te). The additive substantially prevents oxygen anion redox and oxygen loss in an outer portion of the core. The additive may be present below the outer surface of the core. At least a portion of the additive may occupy at least some oxygen vacancies in the core. The cathode particle may have a gradient morphology with the concentration of the additive increasing with radial distance from the center of the cathode particle. The core may have a single-crystalline structure. The core may be LiₓCoO₂ or LiₓNi_{1-y-z}Mn_{y}Co_{z}O₂.

### INCORPORATION BY REFERENCE

U.S. provisional application No. 63/009,372, filed on Apr. 13, 2020, entitled “GRADIENT-MORPH LiCoO2 SINGLE CRYSTALS WITH STABILIZED ENERGY-DENSITY ABOVE 3400 Wh/L IN FULL-CELLS” and U.S. non-provisional application No. PCT/US2021/027036, filed on Apr. 13, 2021, entitled “GRADIENT-MORPH LiCoO2 SINGLE CRYSTALS WITH STABILIZED ENERGY-DENSITY ABOVE 3400 Wh/L IN FULL-CELLS” are incorporated herein by reference in its entirety.

### BACKGROUND

The performance of the cathode in a rechargeable lithium-ion (Li-ion) battery is an important factor in the battery's overall performance. There are many cathode materials available for rechargeable lithium-ion (Li-ion) batteries. One family of cathode materials is Li₁₊ₓ[Co,Ni,Mn,Al]₁₋ₓO₂, where x=0 indicates a cathode material that is not over-lithiated, and x>0 indicates a cathode material that is over-lithiated (also called Li-rich).

LiCoO₂ (LCO) is an attractive cathode material that belongs to this family of cathode materials. LCO has a high volumetric energy density and theoretical specific capacity of 274 mAh/g. However, the cycling voltage of LCO is conventionally limited to 4.35 V vs Li/Li⁺ (also referred to here as V), resulting in a specific capacity of 165 mAh/g or less. Though a higher charging voltage would provide a greater capacity, the voltage is typically limited to provide greater cycling stability and increase the battery's cycling lifetime. The battery cycling lifetimes are often set to meet industrial standards (e.g., capacity retention above 80% over 500 cycles).

Cycling LCO with a higher charging voltage (e.g., >4.5 V) causes rapid degradation of battery performance. Previous reports have found that LCO exhibits considerably decreased capacity and increased polarization and charge transfer resistance when cycled with higher charging voltages. At high voltage, LCO may undergo bulk phase transformations, corrosive pitting, and other detrimental physical changes, resulting in low cycling stability and quick capacity fading. Ongoing research seeks to determine the exact mechanisms that cause quick capacity fading in the Li₁₊ₓ[Co,Ni,Mn,Al]₁₋ₓO₂, family at higher charging voltages.

### SUMMARY

In one aspect, a cathode particle includes a core whose composition includes a lithium (Li) transition metal (M) oxide. The core has an outer surface on which an additive is disposed. The composition of the additive includes at least one of selenium (Se), phosphorus (P), boron (B), or tellurium (Te). At least some of the additive may extend below the outer surface of the core and occupy at least some oxygen vacancies in the core. The cathode particle may have a gradient morphology in which a concentration of the additive increases with radial distance from the center of the cathode particle. At least some of the additive may form a coating disposed around the core.

In another aspect, a method of making a cathode particle includes mixing a lithium (Li) transition metal (M) oxide with a powder that includes at least one of selenium (Se), phosphorus (P), boron (B), or tellurium (Te); applying a compressive force to the lithium (Li) transition metal (M) oxide and the powder; and, heating the lithium (Li) transition metal (M) oxide and the powder to a temperature sufficient to melt the at least one of selenium (Se), phosphorus (P), boron (B), or tellurium (Te).

In another aspect, a battery includes a cathode, an anode, and an electrolyte. The cathode includes a plurality of cathode particles whose composition includes a lithium (Li) transition metal (M) oxide, and at least one of selenium (Se), phosphorus (P), boron (B), or tellurium (Te). The battery is used in a method that includes the steps of: (A) charging the battery to at least 4.5 V vs Li/Li+ at a rate of about 10 mA/g to about 500 mA/g; (B) discharging the battery to about 3.0±0.2 V vs Li/Li+ at a rate of about 10 mA/g to about 500 mA/g; and (C) repeating steps (A) and (B) for at least 450 cycles. The battery has an initial specific discharge capacity of at least about 220 mAh/g. Over the at least 450 cycles, the battery retains an average specific discharge capacity of at least about 80% of the initial specific discharge capacity.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The patent or application file contains at least one drawing executed in color. Copies of this patent or patent application publication with color drawings will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A shows a cathode particle with a continuous coating.

FIG. 1B shows a cathode particle with a non-continuous coating.

FIG. 1C shows a cathode particle with a gradient morphology coating.

FIG. 2A shows an LCO cathode particle with a selenium (Se) coating.

FIG. 2B shows the LCO cathode particle of FIG. 2A with a radially increasing gradient concentration of Se.

FIG. 2C shows an LCO crystal structure with oxygen vacancies (left) and with Se substituting oxygen vacancies (right).

FIG. 2D shows the charge density distribution in the charged LCO lattice with Se substituting an oxygen vacancy.

FIG. 3A shows charge/discharge profiles during cycling of uncoated LCO (top) and Se-coated LCO (bottom).

FIG. 3B shows cycling discharge capacities (top), energy densities (middle top), overpotentials (middle bottom), and Coulombic inefficiencies (bottom) of uncoated LCO and Se-coated LCO in coin half-cells.

FIG. 3C shows cycling retention of discharge capacities, energy densities, and interior resistance of uncoated LCO and Se-coated LCO in pouch full cells.

FIG. 4A shows differential electrochemical mass spectrometry (DEMS) while charging uncoated LCO (left) and Se-coated LCO (right).

FIG. 4B shows Co valence mapping on uncoated LCO (left) and Se-coated LCO (right) in the first cycle (top) and tenth cycle (bottom).

FIG. 4C shows scanning electron microscopy (SEM) images of uncoated LCO (left) and Se-coated LCO (right) after 120 cycles.

FIG. 4D shows high-resolution transmission electron microscopy (HRTEM) images of uncoated LCO (top) and Se-coated LCO particles near the particle surface after 120 cycles and FIB preparation. The fast Fourier transform (FFT) pattern from the HRTEM image is inserted.

FIG. 4E shows Li⁺ diffusivity in uncoated LCO and Se-coated LCO cathodes in the 120^{th} cycle.

FIG. 5A shows oxidative-oxygen-radical emission from a cathode and reaction with carbonate electrolyte.

FIG. 5B shows electron paramagnetic resonance (EPR) measurements from the electrolyte in a battery with an uncoated LCO (left) and Se-coated LCO (right) cathode.

FIG. 5C shows 3D reconstructions of CoO₂⁻, C₂HO⁻, LiF₂⁻, and CoF₃⁻ fragments at the uncoated LCO (top) and Se-coated LCO (bottom) cathode surface after 120 cycles.

FIG. 5D shows electrochemical impedance spectroscopy (EIS) measurements of uncoated LCO and Se-coated LCO in the 120^{th} cycle.

FIG. 5E shows energy dispersive X-ray spectroscopy (EDX) images of C (left) and Co (right) at the graphite anode in a full-cell with an uncoated LCO cathode (top) and Se-coated LCO cathode (bottom) after 200 cycles.

FIG. 6A shows X-ray photoelectron spectroscopy (XPS) measurements of the Se 3d edge of Se-coated LCO during initial high-voltage cycling.

FIG. 6B shows XPS measurements of the Se 3p edge in a Se-coated LCO particle at different depths in the Se-coated LCO particle after 10 cycles. Dashed lines indicate the 3p location of Se, SeO₂, and SeR.

FIG. 6C shows soft X-ray absorption spectroscopy (sXAS) measurements of the oxygen K-edge of uncoated LCO and Se-coated LCO under TEY mode (left) and FY mode (right).

### DETAILED DESCRIPTION

At high voltages used for deep dilithiation, cathode materials may undergo reactions that drastically reduce cycling stability. Previous reports have found that deep dilithiation from some cathode materials involves the oxidation of oxygen ions⁻ (O²⁻→O^{α-}; α<2). For example, delithiating Li₁₋ₓCoO₂ above x=0.5 involves oxygen oxidation. Because of its reduced ionic radius and electrostatic force, O^{α-} is more mobile than O²⁻ within the cathode material, thereby increasing oxygen migration (OM) in the cathode material and oxygen loss (OL) from the cathode material.

OL in cathode materials may result in decreased battery performance in several ways. One way that OL may decrease battery performance is that it may cause irreversible phase transformations (IPTs) in the cathode material. These IPTs may block Li⁺ diffusion. For example, O^{α-} in LCO may react with CoO₂ to form CO₃O₄. CO₃O₄ has a “bad” spinel crystal structure that blocks Li⁺ diffusion, resulting in increased impedance in the battery cell. If CO₃O₄ grows thick enough to enclose the LCO particle, percolating Li⁺ diffusion into and out of the LCO particle may be terminated, causing considerable performance decline. Another way that OL may decrease battery performance is that OL may facilitate electrolyte decomposition. O₂ and O^{α-} radicals released from the cathode are highly oxidative. These radicals may react with the electrolyte to produce a thick cathode-electrolyte interface (CEI). The thick CEI may degrade the battery cycling performance by decreasing capacity and increasing interfacial resistance. These OL mechanisms of battery degradation may not be self-limiting or self-passivating. OL may produce oxygen vacancies (V_{O}) in the cathode, which in turn may produce flaws and microcracks in the cathode, and further drive OL, and IPT propagation deeper into the interior of the cathode.

The inventors have recognized that facilitating HACR reactions in the cathode while substantially preventing OL from the cathode may provide a battery that can cycle stably with a high voltage and high-capacity. Substantially preventing OL from the cathode mitigates or prevents the reactions that can cause rapid capacity fading at high voltage, including IPTs in the cathode material, the formation of oxygen vacancies in the cathode material, and electrolyte decomposition at the cathode interface.

A cathode material treated with an oxygen-fixing additive can cycle with a charging voltage above 4.5 V with a high cycling stability and high capacity. The additive substantially prevents or mitigates OL from the cathode, and in so doing, may suppress or mitigate phase collapse, electrolyte decomposition, CEI growth, and acidic corrosion during high-voltage cycling. The additive may also stabilize interface kinetics in the cathode.

The additive added to the cathode material may include one or more inorganic, metallic elements that form strong oxygen bonds. The additive may include one or more metalloids, including selenium, boron, and/or tellurium. The additive may also include phosphorus. In some embodiments, the additive may include a mixture of two or more inorganic, elements that form strong oxygen bonds (e.g., a mixture of any of selenium, boron, tellurium, and/or phosphorus). In some embodiments, the additive may include one or more compounds made of at least two inorganic elements that form strong oxygen bonds (e.g., boron selenide, boron phosphide, boron telluride, selenium telluride, selenium phosphide, and/or tellurium phosphide).

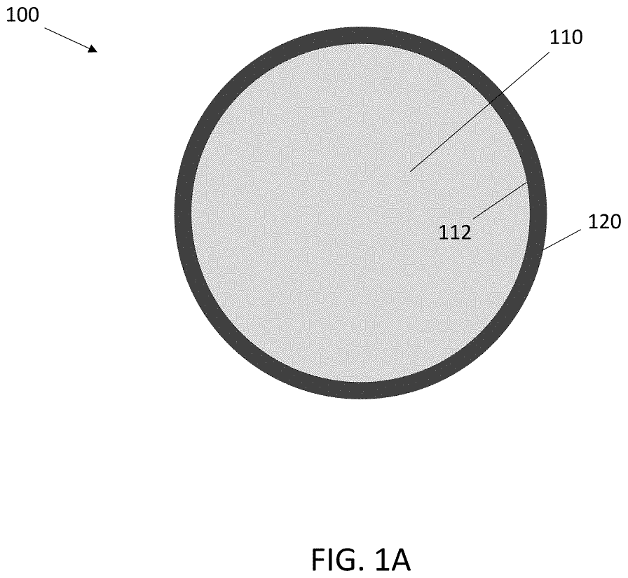

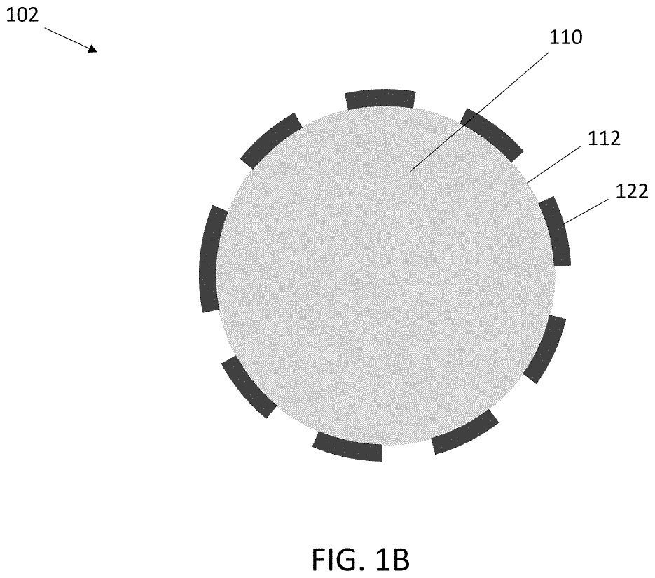

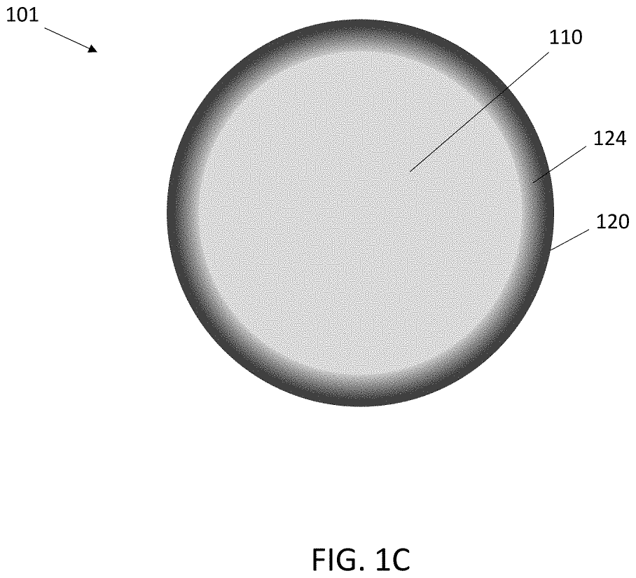

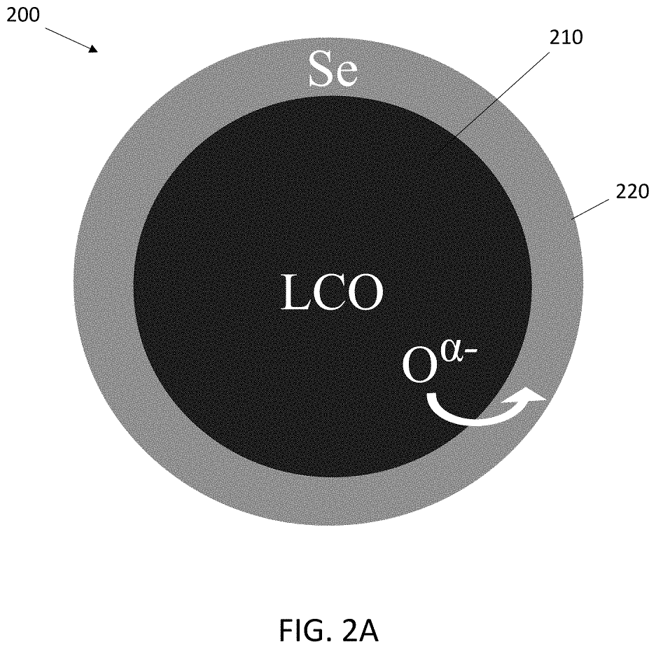

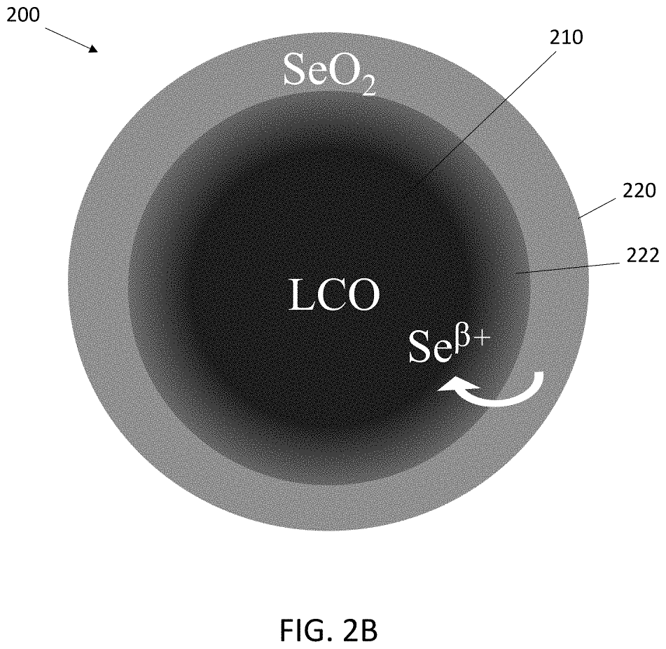

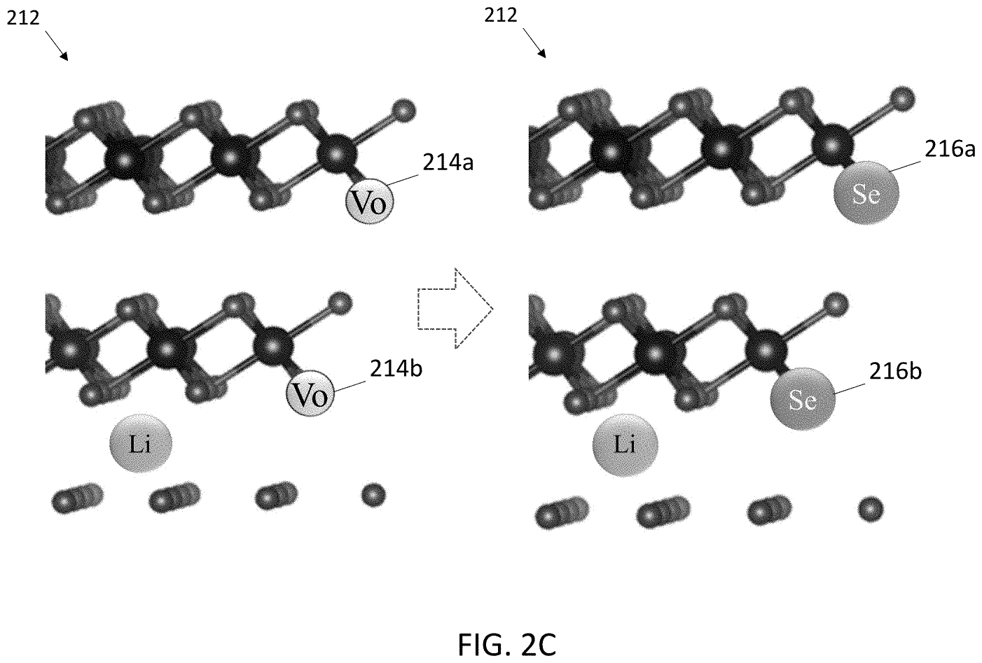

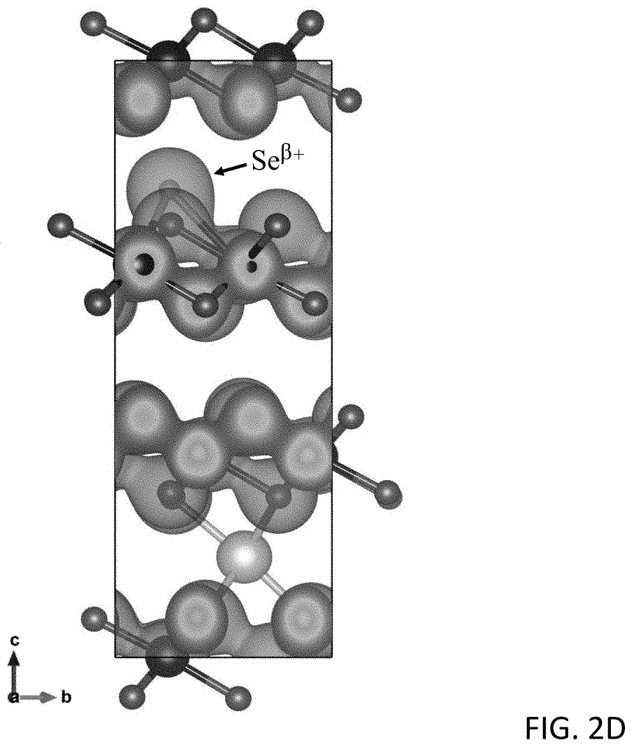

FIGS. 1A and 1B show additive-treated cathode particles with different additive morphologies. FIG. 1A shows a cathode particle 100 with a cathode core 110 and an additive coating 120 disposed around an outer surface 112 of the core 110. The coating 120 is conformal and continuous around the core 110. FIG. 1B shows a cathode particle 102 with an additive coating 122 disposed around an outer surface 112 of the core 110. The coating 122 is noncontinuous around the core 110. The additive coating may be conformal or non-conformal, uniform or non-uniform. Preferably, the coating is conformal. In FIGS. 1A-2B, the cathode particles are depicted as spherical for simplicity. The cathode particles may be any shape.

FIG. 1C shows an additive-treated cathode particle 101 with an additive coating 120 with a gradient morphology 124. With battery cycling, the interface between the additive and the core may become less distinct. As described in more detail below, some additive ions from the additive coating 120 may move into the crystal structure of the core 110 below the outer surface 112 of the core, creating a gradient morphology 124. The gradient morphology is characterized by the concentration of the additive increasing with the radial distance from the center of the cathode particle 101. The gradient morphology depends on the amount of additive present in the cathode material and the number of oxygen vacancy sites in the core material. Additive ions may move into the crystal structure of the core 110 when oxygen vacancies in the core are created. Oxygen vacancies in the core may be created when oxygen leaves the core 110. The additive ions may occupy oxygen vacancy sites in the core and prevent further oxygen loss from the core, thereby limiting the penetration depth of additive ions into the core 110.

The additive in the cathode material has an average weight percent of about 0.01% to about 10% of the cathode particle. Preferably, the additive has an average weight percent of about 0.05% to about 5% of the cathode particle. More preferably, the additive has an average weight percent of about 0.1% to about 2% of the cathode particle.

The average thickness of the additive coating is about 0.1 nm to about 1 μm. Preferably, the average thickness of the additive coating is about 1 nm to about 500 nm. More preferably, the average thickness of the additive coating is about 5 nm to about 100 nm.

The cathode core material is a lithium (Li) transition metal (M) oxide. In one embodiment, the cathode core material has a layered crystal structure and a chemical formula LiMO₂. In this embodiment, M is preferably one or more 3d transition metals. More preferably, M includes at least one of cobalt (Co), nickel (Ni), and/or manganese (Mn) (e.g., LCO, LiₓNi_{1-y-z}Mn_{y}Co_{z}O₂). The layered crystal structure may include other metal elements, including aluminum (Al) (e.g., LiNiₓCo_{y}Al_{z}O₂). Any of these examples of layered cathode core materials may additionally be Li-rich (e.g., Li_{1.7}Mn_{0.50}Ni_{0.24}Co_{0.09}O₂). In another embodiment, the cathode core material has a spinel crystal structure and a chemical formula LiMO₄. In this embodiment, M preferably includes one or more 3d transition metals. More preferably, M includes Mn. The spinel cathode core material may be cubic (e.g., LiₓMn₂O₄) or high voltage (e.g., LiₓMn_{1.5}Ni_{0.5}O₄). In another embodiment, the cathode core material has a disordered rocksalt crystal structure. In this embodiment, the cathode core material has a crystalline rocksalt structure but with a disordered arrangement of Li and M on the cation lattice. The M is preferably one or more 3d or 4d transition metals. More preferably, M includes at least one of Ni, Co, Mn, vanadium (V), iron (Fe), chromium (Cr), molybdenum (Mo), and/or titanium (Ti) (e.g., Li_{1.25}Mn_{0.25}Ti_{0.5}O_{2.0}). The disordered rocksalt cathode core material may include other metal elements, including zirconium (Zr), niobium (Nb), and/or molybdenum (Mo). Some of the oxygen content in the disordered rocksalt cathode may be substituted with fluorine (e.g., Li_{1.25}Mn_{0.45}Ti_{0.3}O_{1.8}F_{0.2}).

The cathode material is a particulate material. Particle size may range between about 50 nm and about 50 μm. Preferably, the particle size is 500 nm to about 10 μm so that the cathode core material has less surface area and uses less additive to create a coating. Preferably, the cathode particles are single-crystalline.

The additive prevents or mitigates OL during battery cycling in several ways. One way that the additive prevents or mitigates OL from the cathode is by fixing mobile oxygen ions. The additive forms an additive oxide (e.g., SeO₂, B₂O₃, TeO₂, or P₂O₅), which may constitute some or all of the additive, including some or all of the coating. The oxide has strong oxygen bonds that provide stability in the electrochemical environment. In this way, the additive reduces mobile oxidized O^{α-} ions to immobile O²⁻ ions. By fixing mobile oxygen, the additive substantially prevents or mitigates the decomposition of the electrolyte. Immobile O²⁻ is less likely than mobile O^{α-} to react with electrolyte at the cathode/electrolyte interface. By fixing mobile oxygen, the additive also prevents the formation of V_{O} by preventing O^{α}—V_{O} exchange.

Another way that the additive may prevent or mitigate OL is by forming a solid additive oxide coating at the surface of the cathode particle. The additive oxide may prevent mobile oxygen from reacting with the electrolyte at the cathode/electrolyte interface without substantially affecting Li⁺ diffusion. The additive oxide may form an inorganic polymer. In one embodiment, the inorganic polymer is a one-dimensional polymer chain comprising additive atoms and oxygen atoms (e.g., SeO₂). In another embodiment, the inorganic polymer is a multi-dimensional polymer chain comprising additive atoms and oxygen atoms (e.g., B₂O₃). The inorganic polymer may be charge-neutral (e.g., SeO₂) or an ionomer (e.g., polyborate or polyphosphate).

Another way that the additive prevents or mitigates OL is by filling V_{O} sites in the cathode core's crystal structure near the interface between the additive and the core. The additive acts as a dopant. The formation of V_{O} in the cathode core's crystal structure facilitates OM by creating a site for O^{α+}—V_{O} exchange. OM promotes the propagation of defects and IPTs into the interior of the cathode particles. By blocking V_{O} sites, the additive mitigates or prevents these processes. As additive ions fill V_{O} sites in the cathode core's crystal structure, the interface between the additive and the core becomes less distinct and may create a gradient morphology.

Preparation of Cathode Material and Implementation in a Battery

The additive is coated onto cathode core particles. Cathode core particles may be prepared or otherwise acquired. Prior to forming the cathode material, the additive material may be milled (e.g., via ball mill) to create additive particles with an average particle size of about 50 nm to about 50 μm. Additive particles were mixed via ball mill with cathode core particles in a desired weight ratio to produce an approximately uniform particle mixture. In one embodiment, the desired weight ratio may approximately correspond with the weight percentages of the two components in the desired final cathode material composition. In another embodiment, the desired weight ratio includes a higher weight percentage of additive (e.g., in 10%-20% excess) in comparison to the desired final cathode material composition in order to account for additive loss during preparation. The approximately uniform particle mixture is pressed under a compressive force of about 5 tons to about 30 tons, preferably about 20 tons (e.g., via a hydraulic press), and then heated to a temperature of about 200° C. to about 500° C. at a pressure of about 0 atm to about 1 atm for about 0.5 hours to about 12 hours. The conditions may be tuned so that sufficient heat and compressive force are applied to melt the additive so that it forms a coating around the cathode core. In some embodiments, this process is conducted in air. In other embodiments, this process is conducted in an inert gas. The resulting material is cooled down to room temperature. After cooling, the material is milled (e.g., via ball milling) to disperse the coated cathode material powder. The final particle size is about 50 nm to about 50 μm.

The coated cathode material powder is used as an active material in battery cathodes. Active materials in a cathode participate in the reversible electrochemical reactions that drive battery charging and discharging. In one embodiment, the coated cathode material powder is the sole active material in the cathode. In another embodiment, the coated cathode material powder is one of at least two different active materials in the cathode. Other active materials may include active materials with different core materials, different additives, or materials that are not coated. The total amount of active material in the cathode is about 80% to about 98%. Preferably the total amount of active material is about 90% to about 96%. The balance of the weight percent of the cathode may include one or more polymeric binders and conductive additives.

A cathode made with the coated cathode material may be used to assemble a Li-ion battery cell. The cell also includes an anode, separator, and electrolyte. The anode may be a material that is electrically conducting and can intercalate Li⁺ to store electrical charge with modest volume expansion (e.g., one or more of graphite, lithium, lithium titanate, hard carbon, tin, and/or silicon). The separator may be any material that facilitates the movement of ions through the cell (e.g., polymer or glass fiber). The electrolyte provides a conductive pathway for the movement of Li⁺ ions between the electrodes. The electrolyte may be one or more organic liquid (e.g., ethylene carbonate, dimethyl carbonate, and/or room-temperature ionic liquids) or polymer gel (e.g., poly(oxyethylene)) with one or more lithium salt (e.g., LiPF₆). The cell may be assembled with high electrolyte (e.g., >10 g/Ah) or lean electrolyte quantities (e.g., about 1 g/Ah to about 10 g/Ah). Battery cells made with the coated cathode material are well suited to a range of rechargeable battery applications, including consumer electronics, smartphones, laptops, and power tools.

Battery cells with the additive-coated cathode may be charged to a high voltage with long cycling stability. The battery cell may be charged to at least 4.45 V. Preferably, the battery cell may be charged to at least 4.50 V. More preferably, the battery cell may be charged to at least 4.55 V. Specifically, the battery cell may be charged to about 4.62 V. The battery cell may be discharged to about 3.0 V±0.2 V, giving a voltage window as wide as about 2.98 V to about 4.62 V. The charging and discharging rates may be about 10 mA/g to about 500 mA/g. For example, the charging and discharging rates may be at least about 10 mA/g. Preferably, the charging and discharging rates may be at least about 30 mA/g. More preferably, the charging and discharging rates may be at least about 60 mA/g. Specifically, the charging and discharging rates may be about 100 mA/g. The battery may cycle stably for at least 100 cycles. Preferable, the battery may cycle stably for at least 200 cycles. More preferably, the battery may cycle stably for at least 300 cycles. Specifically, the battery may cycle stably for at least about 450 cycles. Here, stable cycling is defined as a capacity retention (the ratio of the discharge capacity at cycle n to the initial discharge capacity) of at least about 80%.

Stably cycling may also be associated with a more gradual increase in interior resistance (R) of the battery cell during cycling, where R≡V/2i and i is the cycling current. Preferably, the increase in R over 450 cycles may be less than about 50Ω. More preferably, the increase in R over 450 cycles may be less than about 20Ω. Specifically, the increase in R over 450 cycles may be less than about 5Ω. The more gradual increase in R may facilitate battery cycling with less heat generated, and therefore better safety metrics.

### Example: Selenium-Coated LCO Cathode With Ultrastable High-Voltage Cycling

In order to shut down OL mechanisms at high voltages, commercial LCO single-crystal particles (C-LCO) were coated with a Se additive. During high-voltage charging, the Se coating substantially mitigated or prevented OL from the cathode to prevent oxygen from reacting with the electrolyte. The Se coating also substituted the oxidized O^{α-} at the outer edges of the charged particle surface

$$( {Li}_{1 - x} {CoO}_{2}^{α -} + \frac{3 δ}{2} Se \to L {i}_{1 - x} Co [ {O}_{2 - δ}^{2 -} S {e}_{δ}^{β +} ] + \frac{δ}{2} {SeO}_{2} )$$

to eliminate V_{O} and replenish electrons (Se→Se^{β+}) to the charged O^{α-} ions (O^{α-}→O²⁻), reducing the mobile O^{α-} ions back to immobile O²⁻ at the charged particle surface, to shut down the global oxygen migration that reduces cycling stability in prolonged cycling. Se has an “anti-aging” effect on the cycling performance of LCO at high-voltage by substantially mitigating or preventing OL from the cathode.

The surface Se-treated LCO (Se-LCO) greatly suppressed OL and phase collapse during high-voltage cycling. Moreover, the Se-LCO cathode also mitigated electrolyte decomposition, CEI growth, and acidic corrosion (e.g., HF corrosion) to stabilize the interface kinetics. Se-LCO greatly stabilized cycling when even charged to 4.62 V and exhibited ultrastable high-voltage cycling in full-cells with graphite anodes and ultra-lean electrolyte (2 g/Ah). Ab initio calculations and sXAS analysis were also conducted to understand the mechanism of Se^{β+} substitution at oxygen anion site and stabilization of OL during the high-voltage cycling.

FIG. 2A shows a schematic of a Se-coated LCO particle 200. During cycling, mobile O^{α-} move from LCO 210 to Se 220. The O^{α-} movement creates V_{O} in the LCO lattice. FIG. 2B shows a schematic of the Se-coated LCO particle 200 when Se^{β+} from the Se coating 220 moves into the LCO particle 210 to occupy V_{O} in the LCO lattice. The movement of Se ions into the LCO lattice creates a gradient morphology 222 with increasing concentrations of Se with increasing radial distance from the center of the LCO particle 200. FIG. 2C (left) shows the LCO lattice structure 212 with V_{O} sites 214a and 214b. FIG. 2C (right) shows the LCO lattice structure 212 with Se ions 216a and 216b occupying V_{O} sites 214a and 214 b, respectively.

According to first-principles density functional theory (DFT) relaxation calculations, when the mobile oxidized O^{α-} initially leaves the deeply-charged lattice,

Li₁₋ₓCoO₂→Li₁₋ₓCo[O_{2-δ}□_{δ}]+δO (1)

where □ indicates an oxygen vacancy. Se substitution in these leftover oxygen vacancy (V_{O}) sites in the charged LCO lattice may be favorable. An exchange of O↔Se may be more preferable than having V_{O} in the deeply charged LCO lattice at high voltage. The reaction:

$${Li}_{1 - x} {CoO}_{2}^{α -} + \frac{3 δ}{2} Se \to {Li}_{1 - x} Co [ {O}_{2 - δ} {Se}_{δ} ] + \frac{δ}{2} {SeO}_{2} \qquad ( 2 )$$

results in a Se-substituted lattice near the charged Se-LCO particle surface. In this process, the Se coating 220 may react with mobile oxygen O^{α-} by forming a SeO₂ outer-layer to mitigate or prevent the mobile oxygen O^{α-} from reacting with the electrolyte. Pre-coated metallic Se may be gradually oxidized to SeO₂ in the initial 1 to 20 cycles.

FIG. 2D shows the charge density distribution in the charged Se-LCO lattice calculated from first-principles DFT calculations. These calculations indicated electron transfer from Se atoms to Co atoms, where Se ions in the Se-substituted LCO lattice have a positive valence (Li₁₋ₓCo[O_{2-δ}Se_{δ}^{β+}]). DFT calculations showed that the potential energy barrier of O¹⁺—V_{O} exchange was 0.9 eV, while that of O²⁻—V_{O} exchange was 2.3-4.0 eV. Thus, at room temperature (k_{B}T=0.025 eV), oxygen migration may be possible if (a) α<2, and (b) there is a V_{O} site adjacent to O^{α-}.

The Se role in mitigating or preventing the ill effects of reaction (1) and the resulting oxygen migration may be three-fold: (i) the formation of SeO₂, a one-dimensional solid polymer oxide, prevents mobile oxygen O^{α-} from reacting with the precious electrolyte; (ii) additional Se “plugs” into the V_{O} sites in the LCO lattice near surface, thus reducing oxygen mobility by removing a condition for O^{α-}—V_{O} exchange (otherwise, such V_{O} may migrate toward the interior of the LCO core to further facilitate oxygen migration causing continuous OL); (iii) Se-substitution may transplant pumped charges from the oxidized O^{α-}, by replenishing electrons to the oxidized O^{α-} (Se—Co→O) and reducing the mobile oxidized O^{α-} ions back to immobile O²⁻ ions, so that another condition for O^{α-}—V_{O} exchange is also removed. This is accomplished by the “sacrificial” oxidation of Se (Se→Se^{β+}) in Li₁₋ₓCo[O_{2-δ}Se_{δ}^{β+}]. For such “sacrificial” oxidation of Se to happen, the equilibrium potential of U^{eq}(Se^{β+/0}) may be somewhat lower than U^{eq}(O^{α-/2-}), so instead of oxygen anion-oxidation near the surface, Se is sacrificially oxidized at high voltage, especially when there is V_{O} in the lattice.

The charge density distribution in FIG. 2D also showed that while the substituted Se^{β+} may be near the vacated V_{O} site, it may not be at the V_{O} site exactly but may be significantly elevated toward the adjacent Li layer (LiL). The migration energy barriers of Se^{β+} in LiL were surprisingly small, (<0.35 eV). Thus, the highly charged LCO lattice may also provide fluent kinetic pathways for the operando inward diffusion of Se^{β+} into the LCO lattice to prevent the oxygen migration.

From a crystal chemistry perspective, cation substitution of anion sites may seem quite unusual. However, as FIG. 2D shows, Se^{β+} may not be at the V_{O} site exactly and may be significantly elevated out of the anion plane. Another interpretation may be that “selenite (SeO₃²⁻) like” resonant structures are formed. Se may take the formal charge of β=4+ if oxygen is taken to be 2−, or lower-valence (0<β<4) analogs. “Lithium cobalt selenite” like motifs may form near the cathode particle surface, with a SeO₂ coating on the surface. The Se coating prevents or mitigates HACR-induced OL, plugs V_{O} sites and immobilizes oxygen near the particle surface, which prevents or mitigates further OL and V_{O} pumping into the interior of the LCO core.

For electrochemical tests, pristine commercial LCO particle (C-LCO) (˜10 μm) were obtained. Metallic Se was first milled in ethanol, and then mixed with the C-LCO powders with a weight ratio of 1:100. Then the mixed powder was pressed into a round pallet under 20 tons of pressure and heated in an air furnace at about 240° C. to about 260° C. for 10 hours. Finally, the sample was cooled down with the furnace and milled to a powder for the preparation of the cathode electrode.

The cathode electrode was made of 95 weight percent (wt %) active material (C-LCO or Se-LCO), 3 wt % carbon black, and 2 wt % polyvinylidene fluoride (PVDF) binder, which was pasted on an Al current collector and compressed under 20 MPa. R2032 coin cells were fabricated with the above cathode, a Li metal anode, a Celgard 2400 polymeric separator, and a commercial electrolyte solution of 1.2 M LiPF₆ dissolved in a mixture of EC and DEC with a volume ratio of 1:1. Pouch full-cells were fabricated with the above cathodes, commercial graphite anode (double-side coated), a Celgard 2400 polymer separator and a commercial electrolyte solution of 1.2 M LiPF₆ dissolved in a mixture of EC and DEC with a volume ratio of 1:1, and 2 wt % vinylene carbonate additive. The loading density of the cathodes was 16-17 mg/cm² with ˜3.5 mAh/cm² (tested in half-cell under 0.1 C); The commercial graphite anode had a loading density of ˜12 mg/cm² with ˜3.8 mAg/cm² (tested in half-cell under 0.1 C). The pouch full cells were fabricated with double layers of electrodes (one graphite anode foil with double-sides coated and two LCO cathode foils with single-side coated). The amount of electrolyte added was about 2 g/Ah in the pouch cell.

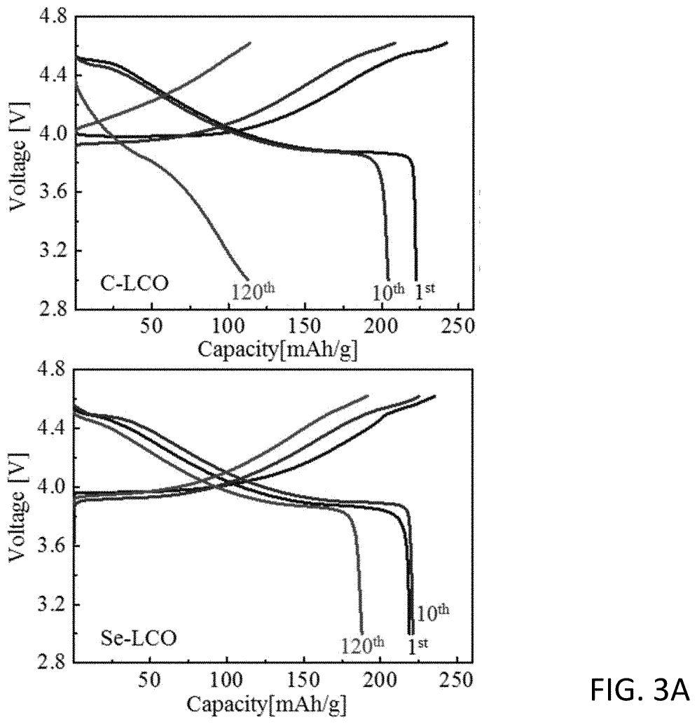

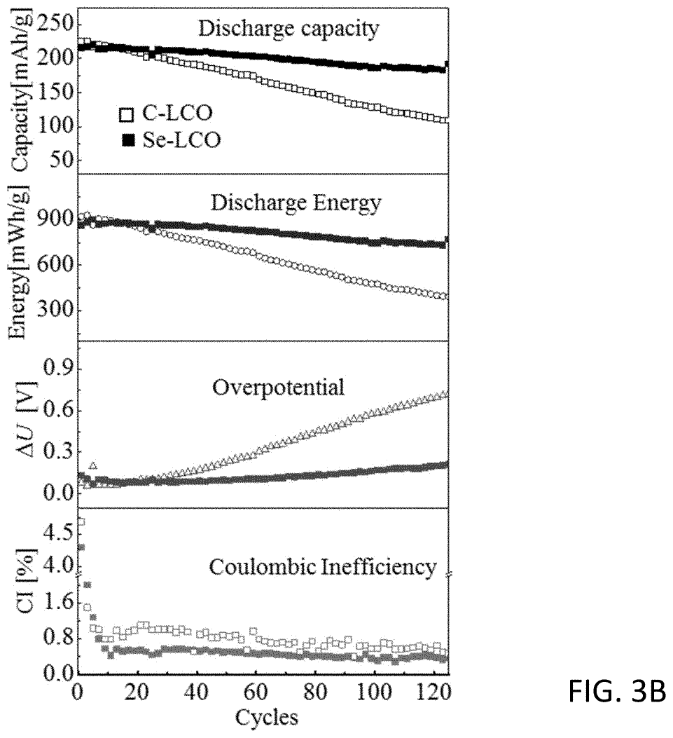

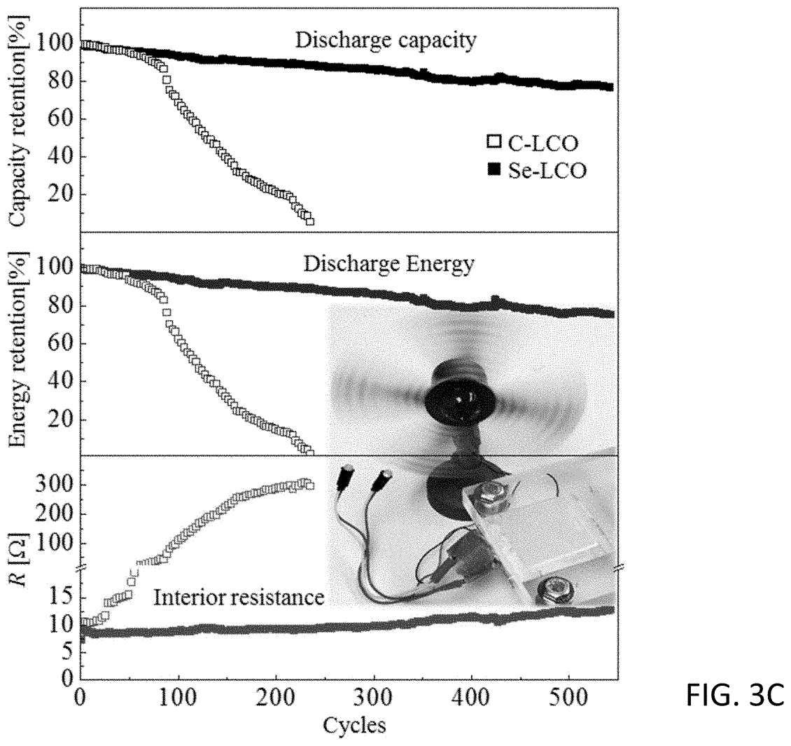

FIG. 3A shows charge/discharge profiles of uncoated LCO (C-LCO) (top) and selenium-coated LCO (Se-LCO) (bottom) within a voltage window of 3.0-4.62 V in coin half-cells under a current of 70 mA/g. The charge/discharge profiles in FIG. 3A showed that in the 1^{st} cycle, C-LCO was charged to 242 mAh/g and discharged to 223 mAh/g, and Se-LCO was charged to 235 mAh/g, discharged to 218 mAh/g. However, while the voltage profile of C-LCO severely deformed after 120 cycles, indicating a devastating high-voltage cycling degradation, that of Se-LCO kept very stable in the 120^{th} cycle.

FIG. 3B shows the cycling discharge capacities (top) energy densities (top middle), overpotentials (bottom middle), and Coulombic inefficiencies (bottom) of C-LCO and Se-LCO cathodes within 3.0-4.62 V in coin half-cells under 70 mA/g. Se-LCO retained 189 mAh/g and 746 mWh/g after 120 cycles, whereas those of C-LCO decreased to 111 mAh/g and 402 mWh/g. Moreover, the overpotential (ΔU≡U_{ch}−U_{disch}, where U_{ch} and U_{disch} was the average charge and discharge potential versus Li⁺/Li) of Se-LCO (ΔU_{Se-LCO}) only increased 170 mV after 120 cycles. However, ΔU_{C-LCO} increased 620 mV after 120 cycles, almost 4 times that of ΔU_{Se-LCO}. The irreversible capacity in each cycle was investigated by comparing the cyclic Coulombic inefficiency (CI≡100%−CE, where CE is Coulombic efficiency) in FIG. 3B. The average CI_{Se-LCO} was less than half of CI_{C-LCO} in cycling, thus the side reactions in Se-LCO cycling were suppressed by at least 50% in each cycle, including that from the electrolyte decomposition and chemical corrosion from the side products (e.g., HF) in electrolyte.

FIG. 3C shows the cycling discharge capacities (top), energy densities (middle), and interior resistance (bottom) of C-LCO and Se-LCO cathodes in pouch full-cells with graphite anodes. The full-cells were cycled under a current of 100 mA/g to 4.57 V followed by a floating current of 40 mAh/g again to 4.57 V and a discharge to 2.95 V under 100 mA/g. The full-cells used an ultra-lean electrolyte (2 g/Ah). The full-cell cycling in FIG. 3C showed that while the capacity and energy density of C-LCO rapidly faded to below 50% within 100 cycles and “died” within 250 cycles, Se-LCO stably retained 80% of its capacity (79% of its energy-density) after 450 cycles and 77% of its capacity (75% of its energy-density) after 550 cycles. The much poorer cycling stability of C-LCO in full-cells compared to half-cells may be due to the quick depletion of the lean electrolyte. In contrast, because the Se-LCO prevented or mitigated OL, it also mitigated electrolyte consumption. Se-LCO displayed much-more stable high-voltage cycling in the full-cell than in the half-cell, indicating Se-LCO's applicability to industrial-scale high-voltage LCO batteries.

The interior resistance (R) of the full-cell was calculated by R≡V/2i, where i was the cycling current, shown in FIG. 3C. C-LCO and Se-LCO had similar initial R of ˜12Ω. While R_{C-LCO} increased ˜300Ω after 250 cycles, R_{Se-LCO} only increased ˜5Ω after 550 cycles, so that the average R increase of Se-LCO (ΔR_{Se-LCO}) in each cycle was less than 1/100 of ΔR_{C-LCO}. The stabilized R of the Se-LCO full-cell maintained the applicable energy density in cycling and decreased heat generation in a practical battery pack. These results indicate the Se-LCO has favorable battery safety under high rates.

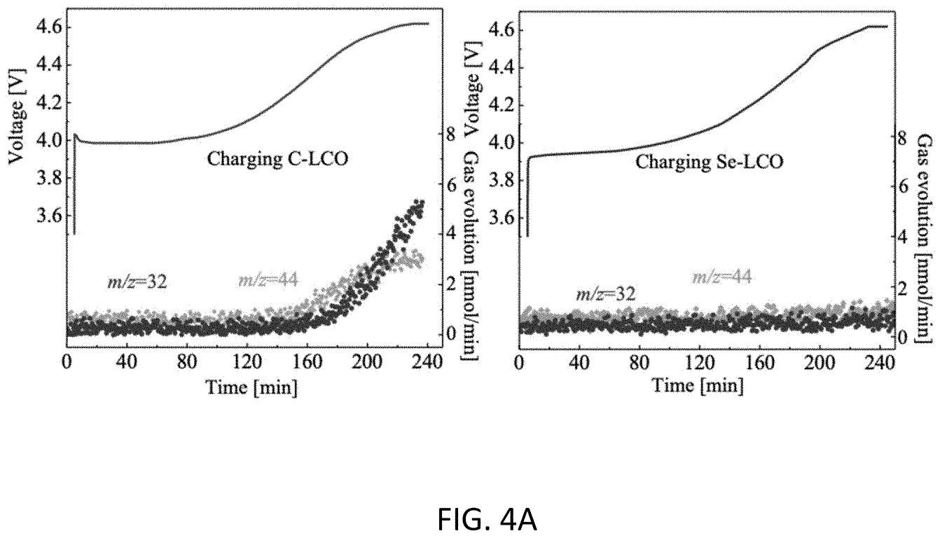

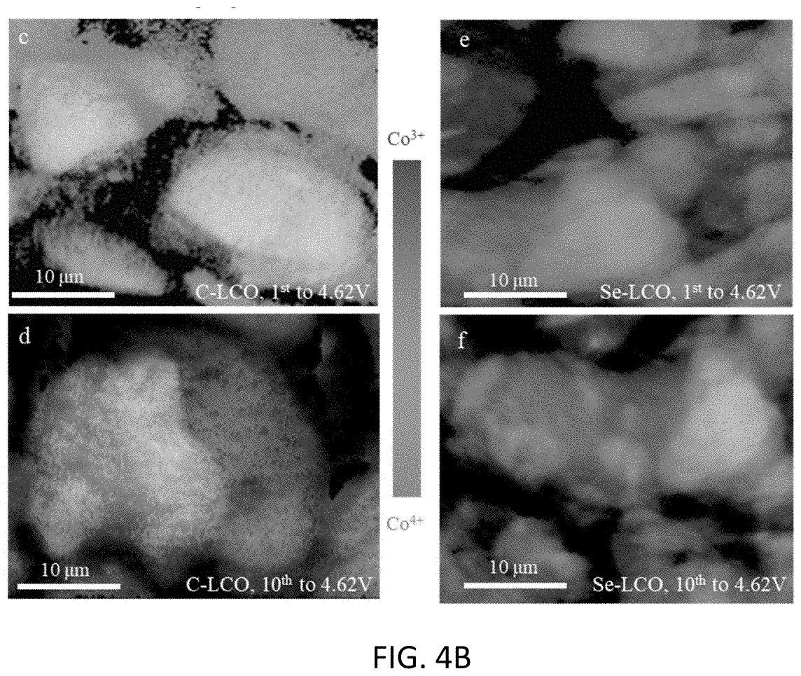

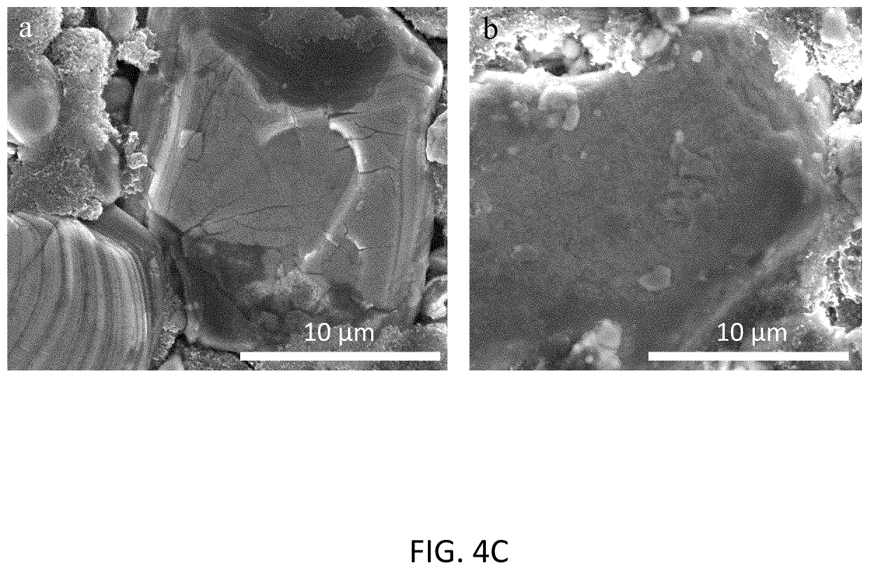

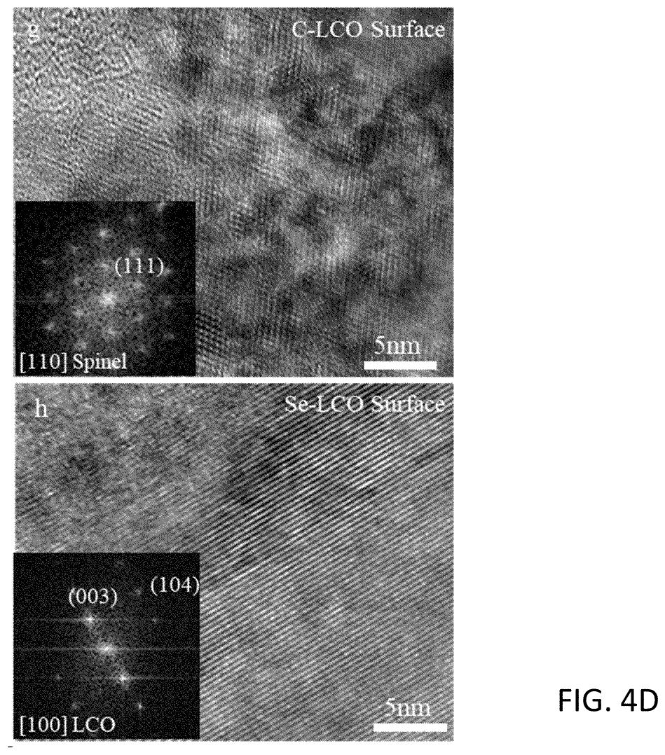

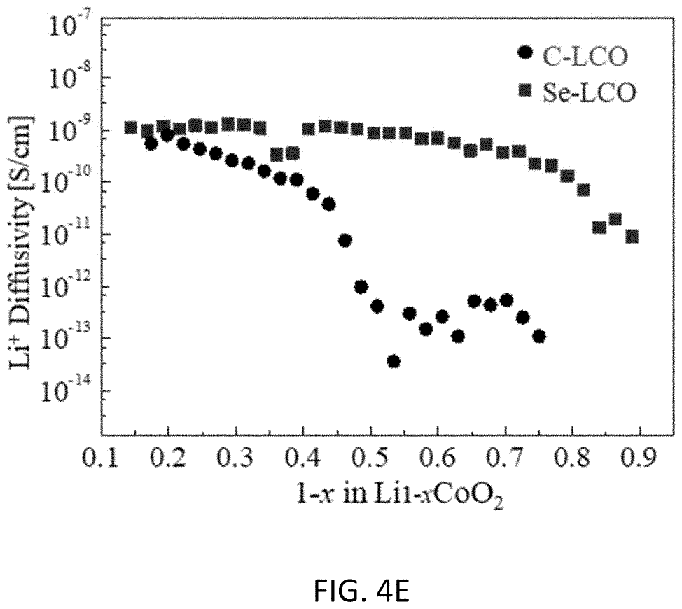

FIG. 4A shows differential electrochemical mass spectroscopy (DEMS) while charging a C-LCO cathode (left) and a Se-LCO cathode (right) to 4.62 V. DEMS monitored O₂ evolution during charging. As shown in FIG. 4A, when charging C-LCO to above 4.5 V, O₂ and CO₂ gas were released, indicating OL from C-LCO and the accompanying electrolyte decomposition during the high-voltage charging. Remarkably, neither O₂ nor CO₂ evolution was detected when charging Se-LCO to 4.62V. The DEMS results demonstrated that the oxygen migration induced OL and electrolyte decomposition were greatly suppressed while charging Se-LCO to high voltage.

FIG. 4B shows cobalt (Co) valence mapping of C-LCO (left) and Se-LCO (right) particles after charging to 4.62 V in the first (top) and 10^{th} (bottom) cycle. The color scheme indicates the Co valence change from +3 to +4. The O₂ escape from the LCO particles in FIG. 4A may result in Co reduction (Co^{2α+}O₂^{α-}→CO₃^{2.7+}O₄/Co²⁺O+O⁰), where the reduced Co ions (Co^{2+/3+}) may migrate to adjacent tetrahedral or octahedral sites, transforming the charged LCO from a layered lattice to a spinel (CO₃O₄) phase. This “bad” spinel phase is not only electrochemically inactive, but also blocks Li⁺ diffusion during cycling. FIG. 4B shows Co XANES mapping tracking the Co valence distribution in charged LCO particles. As shown in FIG. 4B (top left), when first charged to 4.62 V, C-LCO particles showed Co in ˜+4 valence with a few patches of low-valent (below ˜+3.5) at the surface of the particles. After 10 cycles (FIG. 4B bottom left), charged C-LCO particles were almost fully-covered with reduced Co ions. In contrast, there was very little reduced Co ions in the charged Se-LCO particles in either the 1^{st} cycle (FIG. 4B top right) or the 10^{th} cycle (FIG. 4B bottom right). The Co XANES mapping further indicated that OL was prevented or mitigated when Se-LCO was charged to a high voltage.

FIG. 4C shows SEM images of the C-LCO cathode (left) and Se-LCO cathode (right) after 120 cycles. The suppressed OL and Co reduction at high voltage may help stabilize the LCO particle phase in the Se-LCO cathode during cycling. The SEM images in FIG. 4C showed severe cracks and denudation shreds at the C-LCO particle surface after 120 cycles. In contrast, the morphology of the Se-LCO particle maintained a very dense and smooth morphology.

FIG. 4D shows high-resolution transmission electron microscopy (HRTEM) images of a C-LCO particle (top) and a Se-LCO particle (bottom) near the particles' surfaces. The particles were cycled 120 times before focused ion beam (FIB) preparation and imaging. Inserted in FIG. 4D are the FFT patterns from the HRTEM images. The HRTEM images in FIG. 4D indicate that random spinel domains were present near the C-LCO particle surface after 120 cycles. In contrast, Se-LCO preserved an ordered layered lattice. The stabilized layered phase in Se-LCO may facilitate bulk Li⁺ diffusion during battery cycling.

FIG. 4E shows Li⁺ diffusivity within the C-LCO and Se-LCO cathodes in the 120^{th} cycle. Li⁺ diffusivities (D_{Li}⁺) indicated that the average D_{Li}⁺ of Se-LCO was ˜10⁻⁹ S/cm, about 3 orders of magnitude higher than that of C-LCO. The high D_{Li}⁺ of Se-LCO indicated that the kinetics were maintained, and the Se-LCO cell was stabilized during cycling.

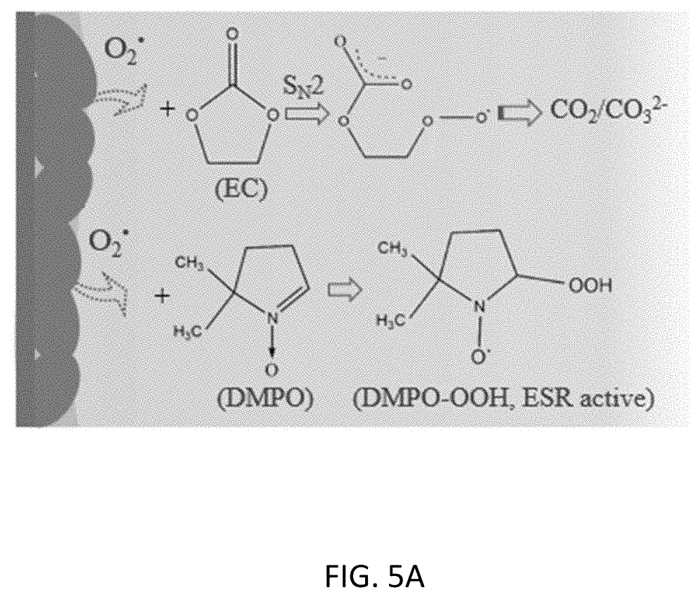

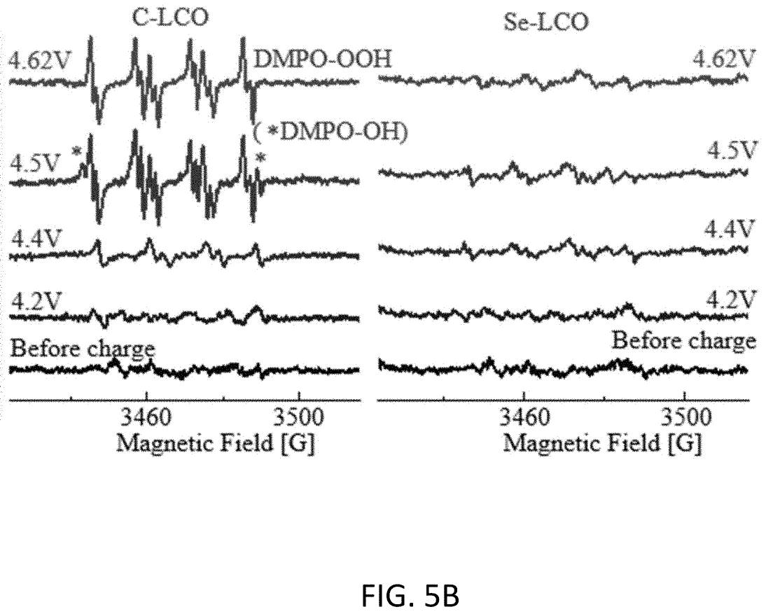

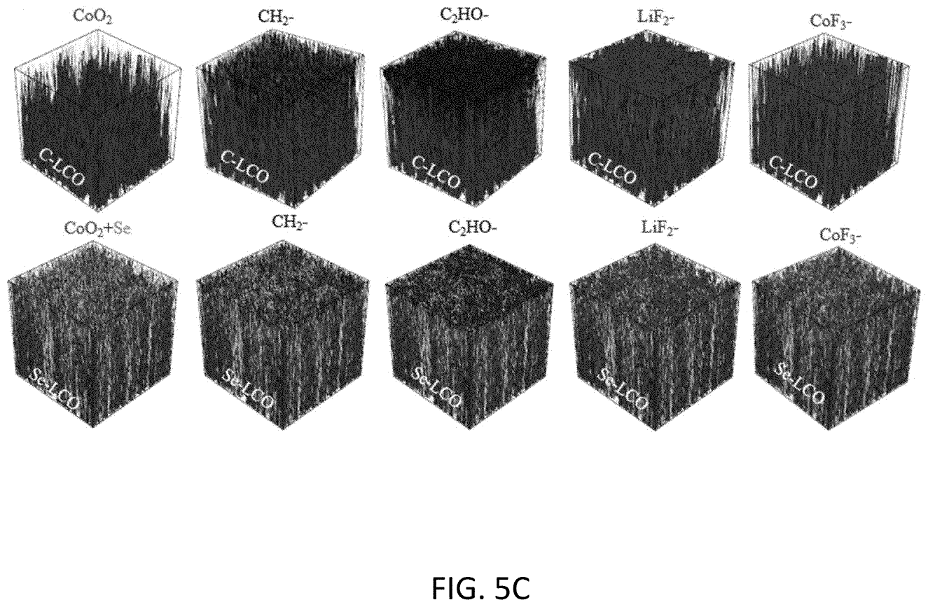

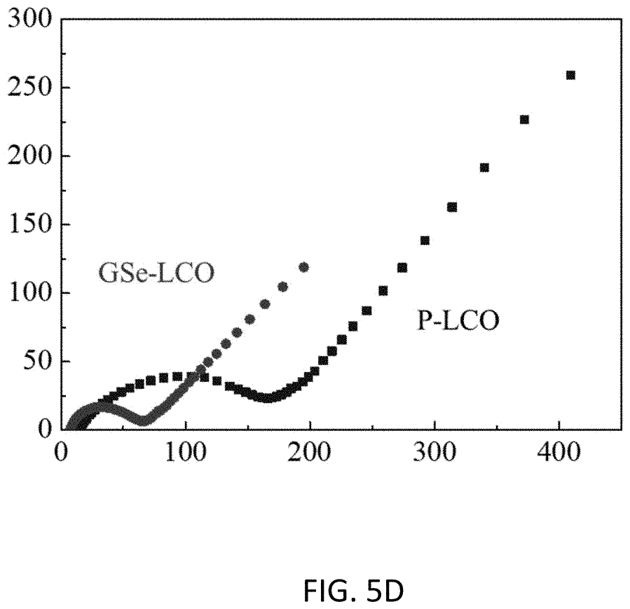

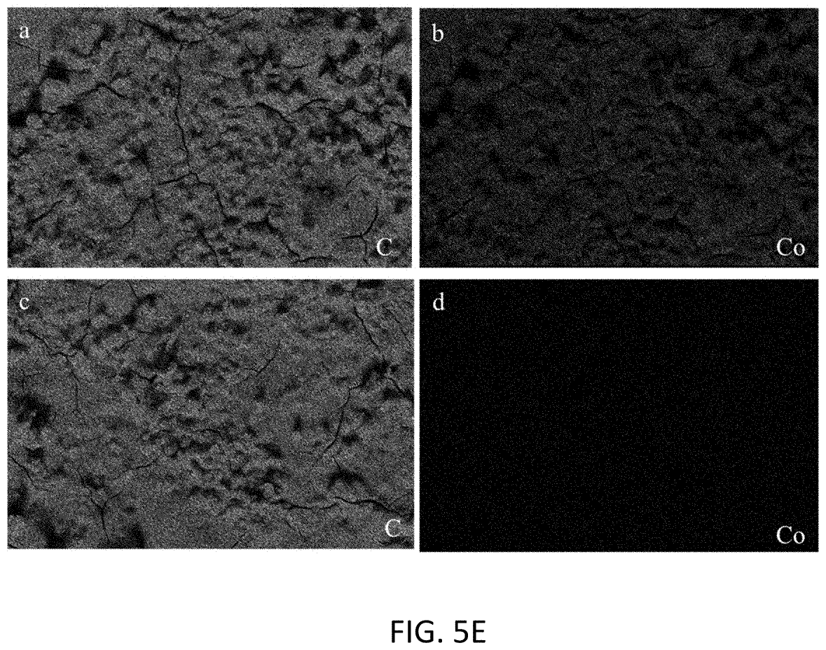

FIG. 5A shows a schematic of the oxidative-oxygen radical emission from the cathode and resulting carbonate electrolyte decomposition that occurs at high voltage. Electrolyte decomposition can be especially aggravated when oxygen radicals are released from the cathode (e.g., hydroxyl HO. or superoxide O₂.). FIG. 5A shows how these radicals can oxidize the carbonate electrolyte with a S_{N}2 attack.

FIG. 5B shows electron paramagnetic resonance (EPR) spectroscopy of the electrolyte during charging of the C-LCO (left) and Se-LCO (right) cathodes. EPR spectroscopy was carried out to measure oxygen-radical emission during charging. For higher experimental accuracy, 10 mM 5,5-Dimethyl-1-pyrroline N-oxide (DMPO) was added into the electrolyte as a radical trapper to extend oxygen radical lifetime. FIG. 5B shows that the electrolyte became EPR active (indicating the presence of oxygen radicals) when charging C-LCO above 4.4 V. Note that the resonance curve after 4.5 V gradually built a typical six-pairs EPR signal attributable to a classical DMPO-OOH adduct. The EPR analysis clearly demonstrated the presence of O₂. (with HO.) emission into the electrolyte when charging C-LCO to above 4.4 V. In contrast, the EPR response from the electrolyte when charging Se-LCO to 4.62 V was very low and did not suggest EPR active DMPO adducts, indicating that the oxidative oxygen-radical emission was suppressed when charging Se-LCO to a high voltage.

FIG. 5C shows 3D reconstructions of CoO₂⁻, CH₂⁻, C₂HO⁻, LiF₂⁻, and CoF₃⁻ fragments at the C-LCO (top) and Se-LCO (bottom) cathode surface after 120 cycles. The suppressed O₂ and oxygen-radical release from Se-LCO may greatly suppress the growth of the CEI layer at cathode surface. Time-of-flight secondary ion mass spectrometry (TOF-SIMS) was used to analyze the cathode surface after 120 cycles and produce the 3D surface reconstruction in FIG. 5C. The C-LCO particle was significantly corroded, as indicated by the surface roughness. In contrast, the Se-LCO particle maintained a very smooth surface, consistent with the SEM morphology in FIG. 4C. CH₂⁻ and C₂HO⁻ fragments represented CEI components in the 3D reconstruction. The Se-LCO cathode had a much thinner CEI layer than the CEI layer on the C-LCO cathode. The thickness of the CEI layer indicates that the carbonate solvent was significantly decomposed in the C-LCO during cycling. In contrast, the thin CEI on the Se-LCO cathode indicates that the Se-LCO cathode mitigated electrolyte decomposition during cycling. The LiF₂⁻ and CoF₃— layers at the Se-LCO cathode surface were much thinner than those at the C-LCO surface after 120 cycles, indicating that the Se-LCO also mitigated acidic corrosion from side-products (e.g., HF) formed in the electrolyte. The much-thinner CEI layer at the Se-LCO particle surface, with less fluoride content, may greatly favor interfacial Li⁺ transfer.

FIG. 5D shows electrochemical impedance spectroscopy (EIS) of C-LCO and Se-LCO cathodes in the 120^{th} cycle. EIS analysis indicated that the interfacial impedance (R_{ct}) of the C-LCO cathode was about 150Ω, and that of the Se-LCO cathode was about 60Ω. The R_{ct} of the Se-LCO cathode was less than half that of C-LCO. These results are consistent with the overpotentials measured in the two cells during high voltage cycling.

FIG. 5E shows EDX mapping of C (left) and Co (right) at the graphite anode after 200 cycles in full-cells with a C-LCO cathode (top) and a Se-LCO cathode (bottom). In comparison to the full-cell with the C-LCO cathode, Co deposition at the graphite anode in the full-cell with the Se-LCO cathode was greatly suppressed. The minimal Co deposition on the graphite anode in the Se-LCO condition indicates that Co in the Se-LCO cathode was more stable during cycling and did not undergo as much acidic corrosion as the C-LCO cathode.

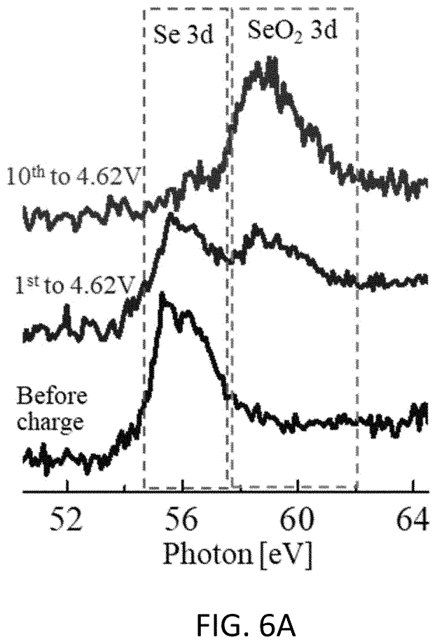

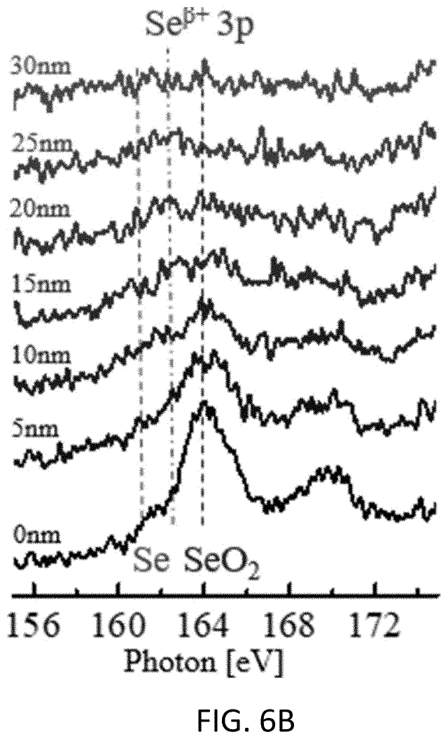

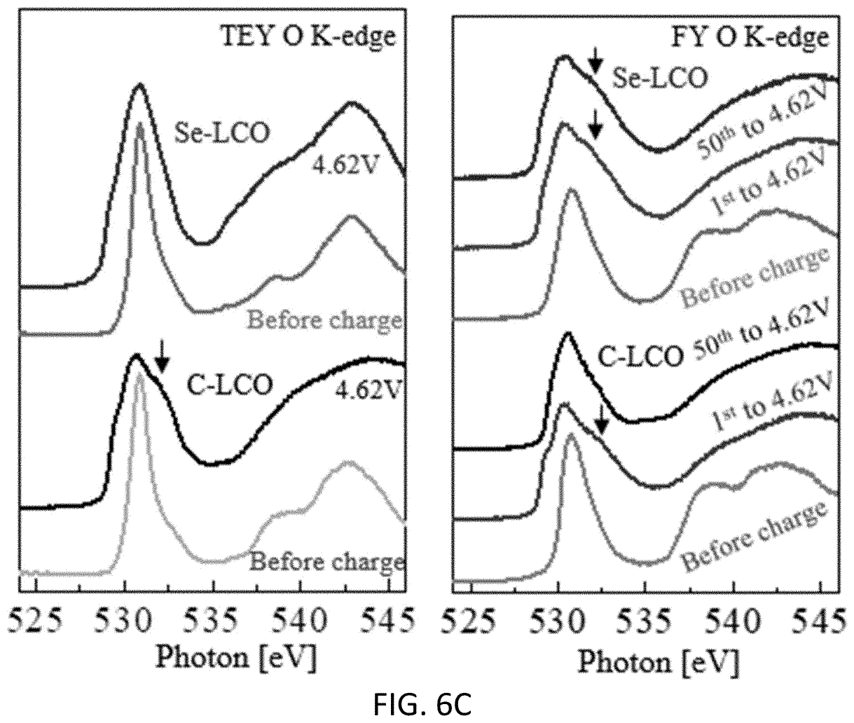

FIG. 6A shows the X-ray photoelectron spectroscopy (XPS) Se 3p edge at different depths in the Se-LCO particle after 10 cycles. The dashed lines indicate, from left to right, the 3p location of Se, Se^{β+}, and SeO₂, respectively. XPS depth analysis confirmed the presence of positive Se^{β+} in the LCO lattice in the Se-LCO particle. A Se 3p peak at ˜162.5 eV between the metallic Se (161 eV) and SeO₂ (164 eV) 3p peaks appeared beneath the SeO₂ outer-layer of the Se-LCO particle, suggesting an average Se valence of 0<β<4. The presence of Se^{β+} below the outer layer of the Se-LCO particle is consistent with Se^{β+} occupying V_{O} sites in the LCO lattice of the Se-LCO particle, as indicated by DFT calculations.

FIG. 6C shows soft X-ray absorption spectroscopy (sXAS) O K-edge spectra of C-LCO and Se-LCO under TEY mode (left) and FY mode (right) at different states of charge.

In FIG. 6C (left), sXAS was performed under TEY mode to investigate the oxidation states of oxygen ions at the charged particle surface. When charged to 4.62V, C-LCO showed a decrease in the peak intensity at ˜530 eV and the appearance of a new peak at a +2 eV higher energy. This new peak indicates the O²⁻→O^{α-} reaction at the C-LCO particle surface. In contrast, the TEY xXAS O K-edge of Se-LCO changed very little, indicating that the oxygen ions remained in a −2 valence state at the charged Se-LCO particle surface.

The mitigation of the O²⁻→O^{α-} reaction at the Se-LCO particle surface may greatly suppress global oxygen migration and OL in the Se-LCO particle at high voltage. Even though the oxygen ions in the particle bulk may still be oxidized, mobile oxygen ions are enclosed in the interior of the LCO core and may not be able to pass the O^{α-}-free Li₁₋ₓCo[O_{2-δ}Se_{δ}] surface. Furthermore, V_{O} in Se-LCO may not be as abundant in the near-surface of the particle as compared to C-LCO, thereby also mitigating global oxygen migration. HACR reactions (O²⁻→O^{α-}) in the bulk of the LCO particle may be more reversible in the prolonged Se-LCO cycling. The FY sXAS O K-edge of C-LCO and Se-LCO in FIG. 6C (right) indicated that both C-LCO and Se-LCO cathodes entailed heavy bulk oxygen anion-redox (O²⁻→O^{α-}) in the 1^{st} charging cycle. After 50 cycles, only the FY O K-edge of Se-LCO remained unchanged. The FY O K-edge of C-LCO showed little fingerprint of oxidized O^{α-} in the 50^{th} charging cycle.

In summary, commercial LCO material was investigated when cycled up to 4.62 V and showed that percolating oxygen migration out of the LCO particle at high voltage caused irreversible phase transformation and aggravated electrolyte decomposition, leading to rapid high-voltage cycling decay. LCO crystals were coated with Se. During deep charging, the Se coating prevented or mitigated oxygen escape from cathode to prevent electrolyte decomposition. The Se coating also substituted part of the mobile O^{α-} in the charged lattice to fill V_{O} sites, and transplanted the pumped charges (2−α)+ from the oxidized O-reducing the mobile O^{α-} ions back to immobile O²⁻ ions, to stop the further oxygen migration. HACR induced OL, phase collapse and electrolyte decomposition were significantly suppressed in prolonged cycling of the Se-LCO cathode. The Se coating promoted ultrastable high-voltage cycling to an unprecedented 4.57 V in pouch full-cells with graphite anodes and an ultra-lean electrolyte (2 g/Ah). The pouch full-cells maintained 77% capacity retention after 550 cycles under 100 mA/g. The antiaging mechanisms of Se modification may be applicable to other lithium transition-metal oxide cathode materials such as NMC/NCM/NCA and overlithiated layered, spinel and disordered rocksalt materials because they all involve oxygen anion-redox at high voltage. The Se coating may prevent OL induced issues in the cathode and stabilize high-voltage, high energy density cycling.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A cathode particle comprising:
a core comprising a lithium (Li) transition metal (M) oxide; and
an additive disposed at least on an outer surface of the core;
wherein the additive comprises at least one of selenium (Se), phosphorus (P), boron (B), or tellurium (Te).

2. The cathode particle of claim 1, wherein:
at least some of the additive is present below the outer surface of the core; and
at least a portion of the at least some of the additive occupies at least some oxygen vacancies in the core.

3. The cathode particle of claim 1, wherein the cathode particle has a gradient morphology in which a concentration of the additive increases with radial distance from a center of the cathode particle.

4. The cathode particle of claim 1, wherein at least some of the additive constitutes a coating disposed around the core.

5. The cathode particle of claim 4, wherein the coating has an average thickness of about 1 nm to about 50 nm.

6. The cathode particle of claim 5, wherein the coating has an average thickness of about 5 nm to about 20 nm.

7. The cathode particle of claim 6, wherein the coating has an average thickness of about 5 nm to about 15 nm.

8. The cathode particle of claim 4, wherein the coating comprises, in whole or in part, at least one of selenium (Se) oxide, phosphorus (P) oxide, boron (B) oxide, or tellurium (Te) oxide.

9. The cathode particle of claim 1, wherein the additive has a weight percent of about 0.01% to about 5% of the cathode particle.

10. The cathode particle of claim 9, wherein the additive has a weight percent of about 0.05% to about 2% of the cathode particle.

11. The cathode particle of claim 10, wherein the additive has a weight percent of about 0.1% to about 1% of the cathode particle.

12. The cathode particle of claim 1, wherein the core has a single-crystalline structure.

13. The cathode particle of claim 1, wherein the core comprises a crystal structure that is at least one of layered, spinel, or disordered rocksalt.

14. The cathode particle of claim 13, wherein the lithium (Li) transition metal (M) oxide comprises at least one of LiₓCoO₂ or LiₓNi_{1-y-z}Mn_{y}Co_{z}O₂.

15. A cathode particle comprising:
a core comprising at least one of LiₓCoO₂ or LiₓNi_{1-y-z}Mn_{y}Co_{z}O₂; and
an additive disposed at least on an outer surface of the core,
wherein:
a first portion of the additive reacts with at least some mobile oxygen ions to form an additive oxide;
a second portion of the additive fills at least some oxygen vacancies in the core; and
the additive substantially prevents oxygen loss from the core.

16. The cathode particle of claim 15, wherein the additive is at least one of selenium (Se), phosphorus (P), boron (B), or tellurium (Te).

17. A method of making a cathode particle, the method comprising:
mixing a lithium (Li) transition metal (M) oxide with a powder comprising at least one of selenium (Se), phosphorus (P), boron (B), or tellurium (Te);
applying a compressive force to the lithium (Li) transition metal (M) oxide and the powder; and
heating the lithium (Li) transition metal (M) oxide and the powder to a temperature sufficient to melt the at least one of selenium (Se), phosphorus (P), boron (B), or tellurium (Te).

18. A method of using a battery, the method comprising:
(A) charging the battery to at least 4.5 V vs Li/Li⁺ at a rate of about 10 mA/g to about 500 mA/g;
(B) discharging the battery to about 3.0±0.2 V vs Li/Li⁺ at a rate of about 10 mA/g to about 500 mA/g;
(C) repeating steps (A) and (B) for at least 450 cycles,
wherein:
the battery has an initial specific discharge capacity of at least about 220 mAh/g;
over the at least 450 cycles, the battery retains an average specific discharge capacity of at least about 80% of the initial specific discharge capacity; and
the battery comprises:
a cathode comprising a plurality of cathode particles comprising:
a lithium (Li) transition metal (M) oxide; and
at least one of selenium (Se), phosphorus (P), boron (B), or tellurium (Te);
an anode; and
an electrolyte.

19. The method of claim 18, wherein the lithium (Li) transition metal (M) oxide has a crystal structure that is at least one of layered, spinel, or disordered rocksalt.

20. The cathode particle of claim 19, wherein the lithium (Li) transition metal (M) oxide is at least one of LiₓCoO₂ or LiₓNi_{1-y-z}Mn_{y}Co_{z}O₂.

21. The method of claim 18, wherein the electrolyte is present in the battery in an amount less than 5 g/Ah.

22. The method of claim 21, wherein the amount of electrolyte in the battery is less than 3 g/Ah.

23. The method of claim 18, wherein over the at least 450 cycles, an increase in an interior resistance of the battery is less than about 5 Ω.
